(19) United States
(12) Patent Application Publication
(10) Pub. No.: US 2006/0032147 A1
(43) Pub. Date: Feb. 16, 2006

(54) Method of preparing slurry composition for chemical mechanical polishing

(76) Inventors: Jae-hyun So, Seoul (KR); Dong-jun Lee, Seoul (KR); Nam-soo Kim, Suwon-si (KR); Sung-taek Moon, Suwon-si (KR); Bong-su Ahn, Seoul (KR); Kyoung-moon Kang, Gwangmyeong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/179,523

(22) Filed: Jul. 13, 2005

(30) Foreign Application Priority Data
Aug. 16, 2004 (KR) 10-2004-0064225

(51) Int. Cl. B24D 18/00; C09K 3/14

(52) U.S. Cl. 51/307; 51/293

(57) ABSTRACT

A method of preparing polishing particles by baking unmilled cerium compound in an environment having a temperature in a range between about 400-700° C., and without dropping the temperature in the environment, applying thermal stress to the resultant cerium oxide in-situ by heating the environment to a temperature in a range between about 700-800° C. to obtain cerium oxide particles.

### BACKGROUND OF THE INVENTION

1. Field of the Invention

The present invention generally relates to method of preparing polishing materials for chemical mechanical polishing (CMP) used in manufacturing a semiconductor device, and a method of polishing a substrate. More particularly, the present invention relates to methods of preparing cerium oxide polishing particles, and methods of polishing a substrate using the cerium oxide polishing particles.

A claim of priority is made to Korean Patent Application No. 10-2004-0064225, filed on Aug. 16, 2004, the disclosure of which is incorporated by reference herein in its entirety.

2. Description of the Related Art

When manufacturing a semiconductor integrated circuit, a surface of a layer formed on a substrate must be processed to a predetermined shape. Chemical Mechanical Polishing (CMP) is a widely used to planarize the surface.

A slurry composition is generally used with CMP. The slurry is composed of polishing particles, such as silica, alumina, and ceria; a dispersion stabilizer; an oxidant; and additives.

Important factors in CMP are polishing speed and quality of a polished surface after CMP, i.e., frequency of scratches occurring on the polished surface. These factors are affected by various types of dispersion stabilizers, oxidants, and additives, but are mainly affected by a degree of dispersion of the polishing particles, characteristics of the polished surface, and crystalline characteristics of the polishing particles.

As the size of the polishing particles or the crystallization of the polishing particles increases, the polishing speed increases and also the frequency of scratches on the polish surface increases. Thus, in order to minimize the occurrence of scratches on a wafer, the size and crystalline characteristics of the polishing particle must be optimized.

A ceria slurry, as compared to a silica slurry, has a higher etch selectivity to an oxide layer over a nitride layer, and thus has attracted much interest as a slurry composition. The ceria slurry also has a higher polishing speed and provides a higher degree of planarization than the silica slurry. The use of the ceria slurry for manufacturing a semiconductor device with a design rule of 0.14 μm or less is becoming more predominant.

There are two general methods of preparing ceria polishing particles for use in a slurry composition. The first method is a liquid phase method in which ceria precursors are oxidized in an aqueous solution to obtain the polishing ceria particles. The second method is a baking method in which ceria precursors are oxidized by directly heating the ceria precursors under a predetermined atmosphere. In the first method, if the ceria particles are prepared using only a liquid phase reaction, ceria crystals are not sufficiently formed. When such polishing particles are used during CMP, it is difficult to attain high polishing speeds.

Accordingly, ceria particles prepared using the liquid phase method and ceria particles prepared using the baking method are additionally heat-treated.

International Published Application No. WO 2000/73211 generally describes a method of preparing cerium oxide by rapidly heating cerium salts at a baking temperature.

Japanese Laid-Open Patent Publication No. Hei 10-106992 generally describes a cerium oxide polishing agent obtained by dispersing cerium oxide particles in a medium.

Japanese Laid-Open Patent Publication No. Hei 10-106991 generally describes cerium oxide polishing particles obtained by dispersing cerium oxide particles in a medium. The cerium oxide particles are obtained by treating cerium hydrate compound at a first temperature, milling the obtained cerium compound, baking the resultant product at a second temperature, and baking again the obtained cerium oxide at a third temperature.

Japanese Laid-Open Patent Publication No. Hei 10-106990 and Japanese Laid-Open Patent Publication No. Hei 10-106989 generally describes cerium oxide polishing particles obtained by dispersing cerium oxide particles in a medium. The cerium oxide particles are obtained by baking cerium hydrate compound at a first temperature, milling the obtained cerium compound, and baking the resultant product at a second temperature.

In the conventional methods described above, the pre-heating, milling and post-heating processes are carried out sequentially to prepare the cerium oxide particles. Such a series of processes is troublesome and costly. In addition, when CMP is performed using the polishing particles, the decrease in the frequency of polishing defects, such as scratches, is limited.

Accordingly, it would be desirable to provide cerium oxide particles having crystalline characteristics which can minimize the frequency of polishing defects, such as scratches, occurring on a polish surface.

### SUMMARY OF THE INVENTION

An embodiment of the present invention, a method of preparing polishing particles comprises baking unmilled cerium compound in an environment having a temperature in a range between about 400-700° C., and without dropping the temperature in the environment, applying thermal stress to the resultant cerium oxide in-situ by heating the environment to a temperature in a range between about 700-800° C. to obtain cerium oxide particles.

In another embodiment of the present invention, a method of preparing a slurry composition used for chemical mechanical polishing (CMP) comprises baking cerium compound in an environment having a temperature in a range between about 400-700° C., without dropping the temperature in the environment, applying thermal stress to the resultant cerium oxide in-situ by heating the environment to a second temperature in a range between about 700-800° C. to obtain cerium oxide particles, dispersing the cerium oxide particles in deionized water to obtain a cerium oxide dispersion, and mixing the cerium oxide dispersion, deionized water, and an additive composition to obtain a cerium oxide slurry.

### BRIEF DESCRIPTION OF THE DRAWINGS

The above and other aspects of the present invention will become more apparent by the description of the detail exemplary embodiments with reference to the attached drawings in which:

FIG. 1 is a flowchart illustrating a method of preparing cerium oxide polishing particles;

FIG. 2 is a temperature graph for cerium oxide in the method of preparing the cerium oxide polishing particles illustrated in FIG. 1;

FIG. 3 is a temperature graph for cerium oxide in the method of preparing cerium oxide polishing particles;

FIG. 4 is a flowchart illustrating a method of preparing a slurry composition for use in chemical mechanical polishing (CMP);

FIG. 5 is a graph illustrating an X-ray diffraction (XRD) spectrum of cerium oxide polishing particles;

FIG. 6 is a graph illustrating an XRD spectrum of the cerium oxide polishing particles;

FIG. 7 is a comparison graph illustrating an estimated total number of polishing scratches on a polished surface after performing CMP using slurry compositions according to embodiments of the present invention and conventional slurries; and

FIG. 8 is a comparison graph illustrating an estimated number of deep polishing scratches on a polished surface after performing CMP using slurry compositions according to embodiments of the present invention and conventional slurries.

### DETAILED DESCRIPTION OF THE INVENTION

A method of preparing cerium oxide polishing particles according to an embodiment of the present invention comprises forming cerium oxide by baking a cerium compound at a first temperature, and applying a thermal stress to the resultant cerium oxide by baking the cerium oxide in-situ at a temperature higher than the first temperature. Thus, crystalline characteristics of the cerium oxide polishing particles are controlled. That is, the cerium oxide is obtained by continuously increasing the temperature in a first bake, and then subjecting the particles to a second bake. The thermal stress applied to the cerium oxide particles during the second bake causes defects to the crystalline structures of the cerium oxide particles. While performing CMP, the cerium oxide particles break at the defects due to external pressure, and thus, the number of polishing scratches on a polished surface is reduced.

FIG. 1 is a flowchart illustrating a method of preparing cerium oxide polishing particles.

Referring to FIG. 1, cerium oxide is formed by baking cerium compounds at a first temperature (S12). The baking is under a preset condition, i.e., temperature, time, and atmosphere, where the cerium compounds are completely oxidized into cerium oxides. The first temperature is preferably in a range of about 400-700° C.

To form the cerium oxides, the temperature is ramped up to the first temperature at a predetermined rate, preferably 0.5-1° C./min, and under air atmosphere, and then the temperature is held at the first temperature for 2.5-5 hours.

The cerium compound may be a conventional ceria precursor. For example, the cerium compound may be Ce₂(CO₃)₃ (cerium (III) carbonate anhydrous), Ce(OH)₄ (cerium hydroxide), CeC₂ (cerium carbide), Ce(O₂C₂H₃)₃·xH₂O (cerium(III) acetate hydrate), CeBr₃ (cerium(III) bromide anhydrous), Ce₂(CO₃)₃·xH₂O (cerium(III) carbonate hydrate), CeCl₃·xH₂O (cerium(III) chloride hydrate), CeCl₃ (cerium(III) chloride anhydrous), CeF₃ (cerium(III) fluoride), CeF₄ (ceric fluoride), Ce₂(C₂O₄)₃ (cerium(III) oxalate), Ce(SO₄)₂ (ceric sulfate), or Ce₂(SO₄)₃ (cerium(III) sulfate anhydrous).

Advantageously, the cerium compound preferably has a melting point higher than the baking temperatures.

The baking process may be performed using a furnace apparatus equipped with, for example, a temperature-controllable heater. The baking may be performed under air atmosphere or under an oxygen-deficient atmosphere, i.e., oxygen concentration lower than air. When the baking is performed under the air atmosphere, the cerium oxide particles have a crystalline structure of CeO₂. Alternatively, when the baking is performed under an oxygen-deficient atmosphere, at least a portion of the obtained cerium oxide particles have a crystalline structure of CeOₓ(0<x<2), wherein the number of oxygen atoms is less than the stoichiometric number of oxygen atoms in CeO₂.

The oxygen-deficient atmosphere is an atmosphere of air and an inert gas (N₂, Ar, or He), which are simultaneously fed into a furnace. The inert gas is preferably fed into the furnace at a flow rate of about 1-5 L/min. Preferably, the flow rate is controlled to maintain oxygen concentration of about 10-20% by volume.

The cerium oxide particles are formed by baking the cerium oxide in-situ at a second temperature higher than the first temperature (S14). That is, thermal stress is continuously applied to the cerium oxides without lowering the temperature.

The thermal stress process is preferably performed under air atmosphere or under an oxygen-deficient atmosphere. However, preferably the atmosphere during step 14 is the same as the atmosphere during step 12.

The thermal stress process is preferably performed at a second temperature, wherein the second temperature is reached in a single step or in a multiple of ramp-up steps. In the multi-step process, the temperature is increased stepwise as the baking time proceeds. The temperature is controlled so that the temperature after each baking step is maintained until a subsequent baking step is performed. Other processing operations, such as milling of the cerium oxides, are not performed between the respective baking steps. A more detailed explanation of the multi-step baking process will be given below.

The thermal stress process comprises ramping up the temperature to the second temperature and then baking the cerium oxide for 2.5-5 hours. When applying the thermal stress to the cerium oxide by a multi-step baking process, the ramping up process and the baking process are repeated a plurality of times.

In the ramping up process, the temperature is preferably increased at a rate of 0.5-1° C./min, and the second temperature is preferably in a range of about 700-800° C.

By applying thermal stress to the cerium oxide particles, the crystalline structure of the cerium oxide becomes non-uniform and the density of the cerium oxide particles is reduced. Thus, the cerium oxide particles have low resistance to external pressure and are easily broken during CMP.

The cerium oxide particles obtained are mixed with deionized water to obtain cerium oxide dispersion (S16). The cerium oxide particles, deionized water, and a dispersant are mixed and stirred. Examples of the dispersant include an anionic organic dispersant, a cationic organic dispersant, and a non-ionic organic dispersant.

An average diameter of the cerium oxide particles in the cerium oxide dispersion is controlled to a desired range by filtering the cerium oxide dispersion (S18). Prior to filtering, if necessary, larger particles can be removed by centrifuge. The filtrate of the cerium oxide particles having desired particle diameters is recovered and mixed again with deionized water to obtain cerium oxide dispersion having controlled particle diameters.

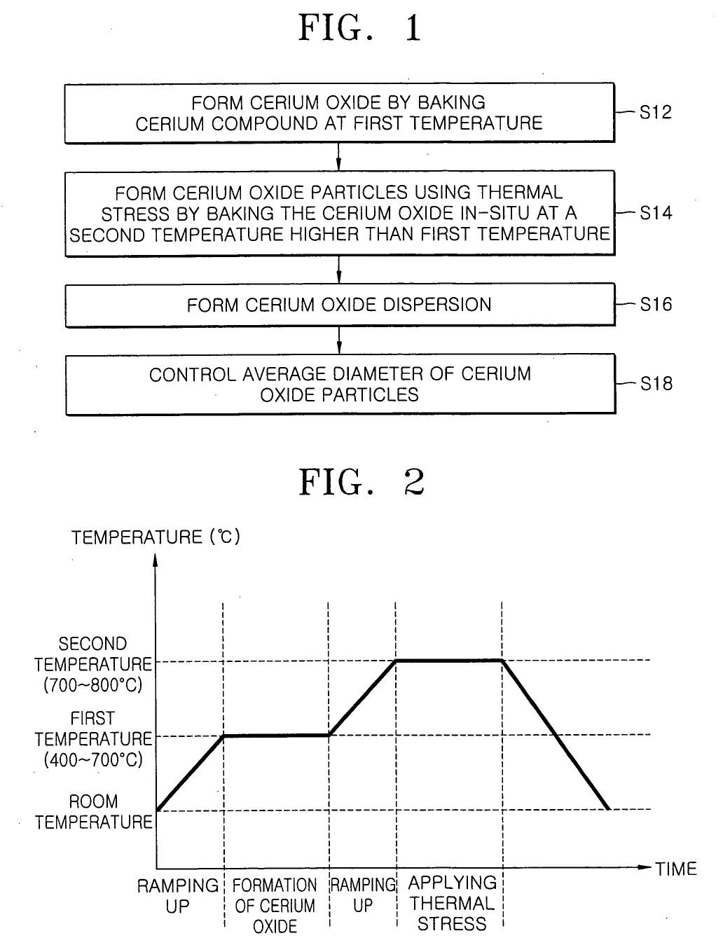

FIG. 2 is a graph illustrating temperatures in steps 12 and 14. Referring to FIG. 2, the cerium oxide is formed by baking cerium compounds at a first temperature, and then, thermal stress is applied to the cerium oxides by a subsequent single-step baking process.

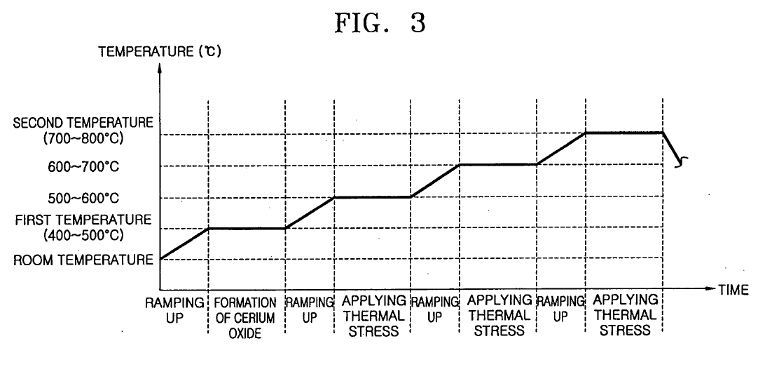

FIG. 3 is a graph illustrating temperatures in steps 12 and 14. Referring to FIG. 3, cerium oxides are formed by baking cerium compounds at a first temperature, and then thermal stress is applied to cerium oxides in a second temperature in three steps.

It should be noted that thermal stress may be performed in various number of steps, i.e., 2, 4, 5, etc.

A slurry composition for CMP comprises the cerium oxide polishing particles prepared using the method illustrated in FIGS. 1-3. The slurry may further comprise a dispersant and a surfactant.

In addition, the slurry composition may further comprise an additive composition to increase polishing selectivity to a specific material layer. The additive composition may comprise a first polymeric acid having a first average molecular weight, a salt of the first polymeric acid containing a first basic material, a second polymeric acid having a second average molecular weight greater than the first average molecular weight, and a salt of the second polymeric acid containing a second basic material. The first polymeric acid may be polyacrylic acid, poly(acrylic acid-co-maleic acid) or poly(methyl vinyl ether-alt-maleic acid), and the second polymeric acid may be polyacrylic acid, poly(acrylic acid-co-maleic acid) or poly(methyl vinyl ether-alt-maleic acid). The first basic material may include sodium hydroxide, potassium hydroxide, ammonium hydroxide, and a basic amine, and the second basic material may include sodium hydroxide, potassium hydroxide, ammonium hydroxide, and a basic amine. Korean Laid-Open Patent Publication No. 2002-9619, generally discloses details of additive compositions.

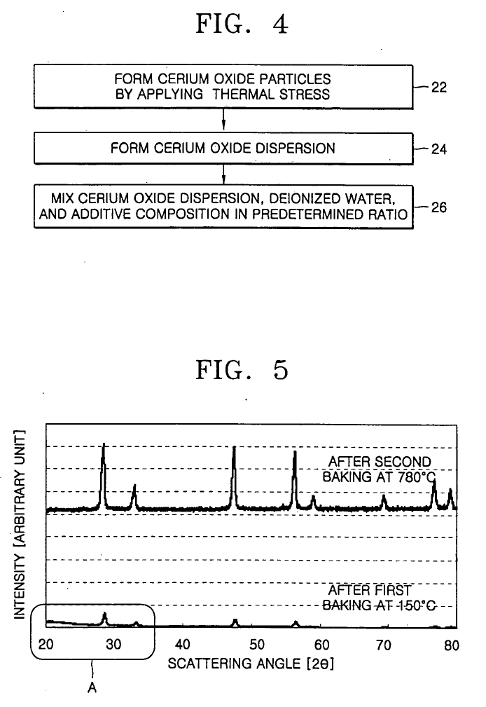

FIG. 4 is a flowchart illustrating a method of preparing a slurry composition for CMP;

First, cerium oxide particles are formed accordingly to methods described with reference to FIGS. 1-3 (S22).

Cerium oxide particles are dispersed in deionized water to obtain cerium oxide dispersion, as explained with reference to step 16 of FIG. 1 (S24). If necessary, the cerium oxide dispersion is obtained through steps 16 and 18 as illustrated in FIG. 1.

The cerium oxide dispersion, deionized water, and an additive composition are mixed in a predetermined ratio to obtain a cerium oxide slurry composition (S26). The cerium oxide slurry composition preferably contains a concentration of the cerium oxide dispersion of about 3-60% by volume. The cerium oxide dispersion contains the cerium oxide particles in a concentration of 5% by weight in deionized water.

Experimental examples to determine the characteristics of the cerium oxide polishing particles according to embodiments disclosed herein will be now described.

### EXPERIMENTAL EXAMPLE 1

A layer on a wafer was polished using a slurry for CMP prepared using cerium oxide polishing particles obtained by multi-step baking. Then, the number of scratches on the polished surface was estimated.

500 g of cerium compound, Ce(OH)₄, was placed in a furnace, the temperature was ramped up to 150° C. at a rate of 0.7° C./min, and then, the temperature was maintained for 3 hours.

After the first bake, the temperature was ramped up to 780° C. at a rate of 0.7° C./min, and then, the temperature was held 3 hours. Thus, cerium oxide particles (Sample 1) were obtained.

FIG. 5 is a graph illustrating analytical results of X-ray diffraction (XRD) spectrum of Sample 1.

As confirmed by portion A of FIG. 5 products obtained after the first bake exhibited broad peaks at small scattering angles (30° or less) and unclear peaks of cerium oxide as compared to the product obtained after the second bake. Thus, it can be concluded that the raw Ce(OH)₄ did not completely oxidize to cerium oxide after the first bake.

### EXPERIMENTAL EXAMPLE 2

The cerium oxide polishing particles obtained in Experimental Example 1 (Sample 1) and cerium oxide polishing particles obtained in the same manner as in Experimental Example 1 except that the first bake was not performed (Sample 2) were each mixed with deionized water and a dispersant, and stirred for 1 hour to obtain slurry solutions. Polyacrylic acid-NH₄OH salt was used as the dispersant. The dispersant had a concentration of 1% by weight based on the total weight of Ce(OH)₄. Each of the slurry solutions was stirred for 100 minutes at 1800 rpm to disperse the polishing particles therein. The obtained dispersions were centrifuged at 150 rpm for 90 minutes to remove large particles having a diameter of 1 μm or greater. The resultant slurry solutions were filtered using a filter having a pore size of 0.5 μm. Then, the filtered materials were diluted with deionized water to prepare cerium oxide dispersions containing the cerium oxide polishing particles in a concentration of 5% by weight.

Each of the sample 1 and sample 2 cerium oxide dispersions having a concentration of 5% by weight was mixed with deionized water and an additive composition in a volume ratio of 1:3:3 to prepare slurry compositions for CMP. An additive composition described in Example 1 of Korean Laid-Open Patent Publication No. 2002-9619, was used.

A plasma-enhanced tetraethylorthosilicate glass film (PE-TEOS film) was formed on a silicon-bare wafer to a thickness of 12000 Å. PE-TEOS film was subjected to CMP for 90 seconds using each of Sample 1 and Sample 2 slurry compositions. Mirra (manufactured by Applied Material, USA) was used as a polishing apparatus. After the polishing, the wafers were cleaned with DHF (deionized water: HF=100:1; volume ratio) and a polyvinyl alcohol brush for 150 seconds. Polishing defects on the PE-TEOS films of the wafers polished and cleaned were determined using “AIT-UV” (KLA-Tencor, USA). In addition, polishing scratches were confirmed using an in-line scanning electron microscope (SEM).

Table 1 shows the number of polishing scratches measured.

TABLE 1

| | | | Second | Total | Number of |
|---|---|---|---|---|---|
| | | First baking | baking | number of | deep |
| | Cerium | temperature | temperature | polishing | polishing |
| | compound | (° C.) | (° C.) | scratches | scratches |
| Sample | Ce(OH)₄ | 150 | 780 | 438 | 61 |
| 1 | | | | | |
| Sample | Ce(OH)₄ | — | 780 | 368 | 59 |
| 2 | | | | | |

Table 1 confirmed that Sample 1, which was subjected to the first bake at 150° C., and Sample 2, which was not subjected to the first bake, did not prevent significant numbers of polishing scratches and deep polishing scratches. Deep polishing scratches refer to polishing scratches having a depth of 1.5 μm or greater. It was determined that the first bake temperature was too low, and therefore, Ce(OH)₄, did not completely oxidize to cerium oxide after the first bake. As a result, the crystalline defects of cerium oxide particles did not fully occur after the second bake.

### EXPERIMENTAL EXAMPLE 3

Cerium oxide particles (Sample 3) were prepared in the same manner as Sample 1 except that the first baking temperature was 400° C.

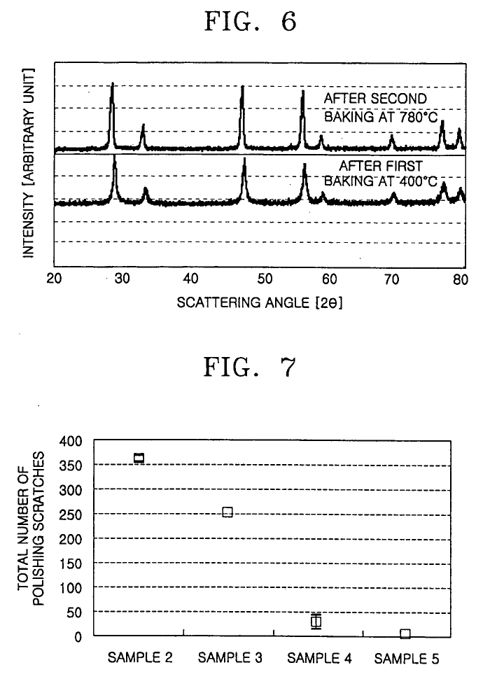

FIG. 6 is a graph illustrating XRD spectrum of the respective products obtained after the first bake and the second bake.

FIG. 6 confirms that both the products obtained exhibited clear peaks, which indicate formation of cerium oxides, without exhibiting broad peaks at small scattering angles. Thus, it can be seen that Ce(OH)₄ was completely oxidized to cerium oxide after the first baking at 400° C.

### EXPERIMENTAL EXAMPLE 4

Slurry compositions for CMP were prepared using the cerium oxide polishing particles obtained in Experimental Example 2 (Sample 2), Experimental Example 3 (Sample 3), cerium oxide polishing particles obtained in the same manner as in Experimental Example 2 except that Ce₂(CO₃)₃ was used in place of Ce(OH)₄ as the cerium compound (Sample 4), and cerium oxide polishing particles obtained in the same manner as in Experimental Example 3 except that Ce₂(CO₃)₃ was used in place of Ce(OH)₄ as the cerium compound (Sample 5), respectively.

The respective cerium compounds used as source materials for Samples 2, 3, 4, and 5 and the baking conditions are summarized in Table 2.

TABLE 2

| | | | Second baking |
|---|---|---|---|
| | | | temperature for |
| | | First baking | applying thermal |
| | | temperature | stress |
| | Cerium compound | (° C.) | (° C.) |
| Sample 2 | Ce(OH)₄ | — | 780 |
| Sample 3 | Ce(OH)₄ | 400 | 780 |
| Sample 4 | Ce₂(CO₃)₃ | — | 780 |
| Sample 5 | Ce₂(CO₃)₃ | 400 | 780 |

PE-TEOS films on silicon-bare wafers were polished in the same manner as in Experimental Example 2 using the slurry compositions for CMP which were prepared using Samples 2, 3, 4, and 5, respectively. Then, polishing defects on the PE-TEOS films were determined.

FIG. 7 is a graph illustrating the estimated total number of polishing scratches among polishing defects on the PE-TEOS films after performing CMP using the slurry compositions for CMP.

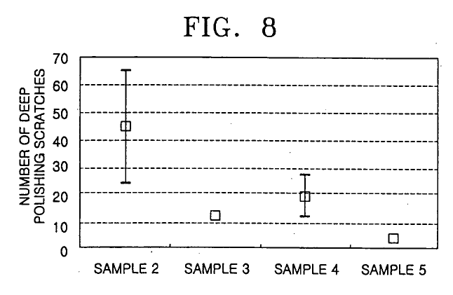

FIG. 8 is a graph illustrating the estimated number of deep polishing scratches among polishing defects on the PE-TEOS films observed using an in-line SEM. The deep polishing scratches refer to polishing scratches having a depth of 1.5 μm or greater.

Referring to FIGS. 7 and 8, when a first baking at 400° C. was performed, the total number of polishing scratches and the number of deep polishing scratches on the polished surface were reduced. That is, by raising the first baking temperature to 400° C., thermal stress on cerium oxide polishing particles causes crystalline defects during the second bake, thus decreasing the hardness of the cerium oxide polishing particles. Accordingly, while performing CMP, the defective cerium oxide particles are easily broken due to external pressure, and thus, the number of polishing scratches occurring on the polished surface is reduced.

While the present invention has been particularly shown and described with reference to exemplary embodiments thereof, it will be understood by those of ordinary skill in the art that various changes in form and details may be made therein without departing from the scope of the present invention.

What is claimed is:

1. A method of preparing polishing particles, comprising:
baking unmilled cerium compound in an environment having a temperature in a range between about 400-700° C.; and
without dropping the temperature in the environment, applying thermal stress to the resultant cerium oxide in-situ by heating the environment to a temperature in a range between about 700-800° C. to obtain cerium oxide particles.

2. The method of claim 1, wherein the baking step and the thermal stress step are performed at an atmospheric pressure.

3. The method of claim 1, wherein the baking step and the thermal stress step are performed under an atmosphere having an oxygen concentration lower than air.

4. The method of claim 1, wherein the baking step and the thermal stress step are performed under atmospheric pressure with an inert gas.

5. The method of claim 1, wherein the baking is for 2.5-5 hours.

6. The method of claim 1, wherein the first temperature is reached by increasing the temperature at a rate of 0.5-1° C./min.

7. The method of claim 1 wherein the applying the thermal stress comprises:
ramping up the temperature; and
holding the temperature for 2.5-5 hours.

8. The method of claim 7, wherein the ramping up of the temperature occurs in a plurality of steps.

9. The method of claim 1, wherein the temperature is ramped up at a rate of 0.5-1° C./min.

10. The method of claim 1, wherein the cerium compound is selected from the group consisting of Ce₂(CO₃)₃ (cerium (III) carbonate anhydrous), Ce(OH)₄ (cerium hydroxide), CeC₂ (cerium carbide), Ce(O₂C₂H₃)₃·xH₂O (cerium(III) acetate hydrate), CeBr₃ (cerium(III) bromide anhydrous), Ce₂(CO₃)₃·xH₂O (cerium(III) carbonate hydrate), CeCl₃·xH₂O (cerium(III) chloride hydrate), CeCl₃ (cerium(III) chloride anhydrous), CeF₃ (cerium(III) fluoride), CeF₄ (ceric fluoride), Ce₂(C₂O₄)₃ (cerium(III) oxalate), Ce(SO₄)₂ (ceric sulfate), and Ce₂(SO₄)₃ (cerium(III) sulfate anhydrous).

11. A method of preparing a slurry composition used for chemical mechanical polishing (CMP), comprising:
baking cerium compound in an environment having a temperature in a range between about 400-700° C.;
without dropping the temperature in the environment, applying thermal stress to the resultant cerium oxide in-situ by heating the environment to a second temperature in a range between about 700-800° C. to obtain cerium oxide particles;
dispersing the cerium oxide particles in deionized water to obtain a cerium oxide dispersion; and
mixing the cerium oxide dispersion, deionized water, and an additive composition to obtain a cerium oxide slurry.

12. The method of claim 11, wherein the baking step and the thermal stress step are performed at an atmospheric pressure with air, an oxygen-deficient atmosphere having a lower oxygen concentration than air, or with air and an inert gas.

13. The method of claim 11, wherein the baking is for 2.5-5 hours, and the thermal stress is for 2.5-5 hours.

14. The method of claim 11, wherein the cerium compound is selected from the group consisting of Ce₂(CO₃)₃ (cerium (III) carbonate anhydrous), Ce(OH)₄ (cerium hydroxide), CeC₂ (cerium carbide), Ce(O₂C₂H₃)₃·xH₂O (cerium(III) acetate hydrate), CeBr₃ (cerium(III) bromide anhydrous), Ce₂(CO₃)₃·xH₂O (cerium(III) carbonate hydrate), CeCl₃·xH₂O (cerium(III) chloride hydrate), CeCl₃ (cerium(III) chloride anhydrous), CeF₃ (cerium(III) fluoride), CeF₄ (ceric fluoride), Ce₂(C₂O₄)₃ (cerium(III) oxalate), Ce(SO₄)₂ (ceric sulfate), and Ce₂(SO₄)₃ (cerium(III) sulfate anhydrous).

15. The method of claim 11, wherein the cerium oxide dispersion contains the cerium oxide particles in a concentration of 5% by weight in deionized water.

16. The method of claim 11, wherein the cerium oxide slurry contains the cerium oxide dispersion in a concentration of 3-60% by volume, and the cerium oxide dispersion contains the cerium oxide particles in a concentration of 5% by weight in deionized water.

17. The method of claim 11, wherein the additive composition comprises a first polymeric acid having a first average molecular weight, a salt of the first polymeric acid containing a first basic material, a second polymeric acid having a second average molecular weight greater than the first average molecular weight, and a salt of the second polymeric acid containing a second basic material.

18. The method of claim 17, wherein the first polymeric acid is polyacrylic acid, poly(acrylic acid-co-maleic acid) or poly(methyl vinyl ether-alt-maleic acid), the second polymeric acid is polyacrylic acid, poly(acrylic acid-co-maleic acid) or poly(methyl vinyl ether-alt-maleic acid), the first basic material includes at least one material selected from the group consisting of sodium hydroxide, potassium hydroxide, ammonium hydroxide, and a basic amine, and the second basic material includes at least one material selected from the group consisting of sodium hydroxide, potassium hydroxide, ammonium hydroxide, and a basic amine.

19. The method of claim 11, wherein the first temperature is reached by increasing the temperature at a rate of 0.5-1 ° C./min.

20. The method of claim 11, wherein the second temperature is ramped up at a rate of 0.5-1° C./min.
